(19) United States
(12) Patent Application Publication
(10) Pub. No.: US 2022/0138513 A1
(43) Pub. Date: May 5, 2022

(54) MULTI-SENSOR DATA OVERLAY FOR MACHINE LEARNING

(71) Applicant: Point Road Solutions, LLC, Belmont, MA (US)

(72) Inventor: Kathleen Wienhold, Arlington, MA (US)

(73) Assignee: Point Road Solutions, LLC, Belmont, MA (US)

(21) Appl. No.: 17/453,171

(22) Filed: Nov. 1, 2021

Related U.S. Application Data
(60) Provisional application No. 63/107,842, filed on Oct. 30, 2020.

(51) Int. Cl. G06K 9/62; G06T 7/20; G06T 7/00; G06N 20/00

(52) U.S. Cl. CPC G06K 9/6288; G06K 9/6228; G06N 20/00; G06T 7/20; G06T 7/97; G06K 9/6256

(57) ABSTRACT

The present invention relates to the reduction of multi-sensor data when used as input to machine-learning (ML) models. Typically, ML models use sensor data to learn characteristics of a problem domain. This data is usually input to the ML model in an end-to-end fashion: the data from sensor 1 is appended with the data from sensor 2, etc., until the entire concatenated data set forms a single input example from which the model learns. The more sensors, the more data, the larger the size of the data input to the ML model, and the longer it is likely to take to train and run the model.

Disclosed is a method to combine data from multiple sensors, reducing it into a smaller input data space. The data from 2 or more sensors of the same type can be combined in the same input data space, to simplify the input data size, enabling smaller, faster machine-learning models.

### FIELD OF INVENTION

The invention relates generally to a system and process for creating compact expressions of sensor data that can be used as input to machine learning

### BACKGROUND—Sensors

Sensors used to monitor an area (for perimeter security or other similar applications) usually overlap their field of view (FOV) from one instance to the next (see FIG. 1 for an example sensor deployment). The purpose of this overlap is both to ensure coverage and to compensate for what may be less precision at the margins of a sensor's detection area,

Examples of sensors used in these kinds of applications include cameras, radars, LIDARS, etc., with possible sensor output data types including images, point-clouds, and occupancy grids.

Such applications are typically interested in changes in the environment they monitor—changes which can be summarized as “motion” between one frame of data and the next. For example, motion in a video stream may be indicated by a pixel position in one frame having a different color value in the next frame; motion in a LIDAR point-cloud may be the presence of a point in one frame and its absence in the next; motion in a radar point-cloud may be indicated by doppler values. Area-monitoring applications typically use only the “motion” values, discarding static sensor values as uninteresting.

Sensors which output continuous values typically need quantization before being used in a machine-learning (ML) model. For example, digital image data is already quantized, in that each pixel has an RGB (red-green-blue) value. The position of these pixels is consistent from frame to frame. Quantizing point-cloud data is typically done in an occupancy grid, as shown in FIG. 2, where all data points within a certain grid square combine their values to form a single value representing that grid element. The 2D example shown is generalizable into voxels (=“volume pixels” or a 3D occupancy grid) and higher N-dimensional data spaces as well.

Some sensors which produce point-cloud data have used ML algorithms for segmentation and classification of static scenes (that is, dividing a point cloud up into distinct groups which comprise objects, and attempting to match these point-cloud segments to specific object types (example: PointNet—Qi, Su, Mo & Guibas, “PointNet: Deep Learning on Point Sets for 3D classification and Segmentation”, Stanford University, 2017)). Classification of time-series point-cloud data has also been explored, using an ML algorithm on time-series radar to do person identification. Zao, Lu, Wang, Chen, Wan, Trigoni & Markham, “mID: Tracking and Identifying People with Millimeter Wave Radar”. Note that these applications are working with point-cloud data from a single sensor source.

### BACKGROUND—Machine Learning

A typical machine-learning (ML) application entails using large amounts of data to train a model to make distinctions among inputs, without requiring the engineers to specify exactly how the inputs differ. The model learns the differences by learning inherent features of the (large number of) positive and negative examples shown it in its problem domain. ML models operate on many kinds of input: image, text, audio, point-cloud, etc.—if it can be encoded into a digital format, you can make it an input to an ML model.

Some ML problem domains require using time-series data. For example, a single photo of a highway [not time-series input] gives no information about the speed or trajectories of the vehicles on it. Whereas a video of a highway [time-series input] makes such a calculation simple, Time-series data is typically 1-2 orders of magnitude larger that similar static data, making the problem space correspondingly larger.

Significant engineering time and resources may be spent if the amount of data required by a ML application becomes large in comparison to the available computing resources. If the space of possible input examples to the ML model is large, the model is likely to require more training examples, and to take longer to train and run.

The training of ML models with time-series data requires a lot of training data. ML in all new problem domains (time-series or not) often runs into the problem of not having enough data to adequately train a system. [It is often noted in engineering literature that most of the time spent developing an ML system is spent in acquiring, cleaning, formatting and massaging the data, before one ever begins to specify the model architecture and train the system.] Various data-augmentation techniques have been developed to artificially inflate training data, to provide more training input. For example, image data may be rotated, flipped, squeezed/stretched, etc., to provide more training input to vision systems. Similarly, point-cloud data may be rotated in 3D space or offset one voxel in an occupancy grid to provide additional training values. Zao, Lu, Wang, Chen, Wan, Trigoni & Markham, “mID: Tracking and Identifying People with Millimeter Wave Radar”.

### SUMMARY OF THE INVENTIONS

The present invention relates to a system inclusive of an array of multiple sensors that collect individually data portable to a singular input data space. The data is foHnatted in a more compact expression. The data space is accessible by a device that performs machine learning. The more compact expression of the data enables faster and smaller machine learning models. The present invention also related to a process for retrieving data through an array of multiple sensors, formatting the data in a more compact expression, porting the data to a data space, and delivering the data for use in machine learning.

### FIGURES

FIG. 1: Example Sensor Deployment with Overlapping Fields of View (FOV)

FIG. 2: Quantization of Points into Occupancy Grid

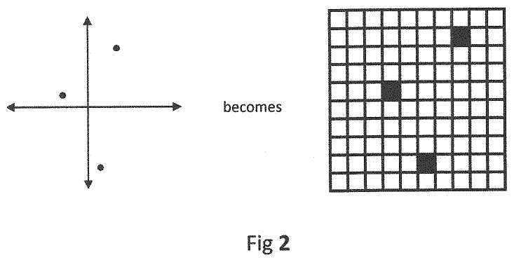

FIG. 3: Naive Multi-Sensor Data Format for Machine Learning

FIG. 4: Less Naive Multi-Sensor Data Format for Machine Learning

FIG. 5: Point-Cloud Overlay for Moving Target Classification

FIG. 6: Point-Cloud Overlay / Wrap-Around to Form Single Input Space

FIG. 7: Point-Cloud Data Pipeline with Motion Filter & Overlay

### DETAILED DESCRIPTION OF THE EMBODIMENTS

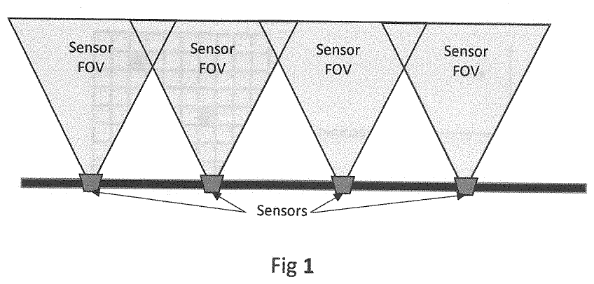

Consider an object moving left-to-right through the area-of-detection for the sensor deployment shown in FIG. 1. The object will be detected in the FOV for each successive sensor. The data these sensors gather may be fed into an ML model for any number of applications, including object trajectory projection (where is it going?), object classification (is it a person? a dog? a drone?), target intent (is this person running9 walking? sneaking?) and other applications.

Depending upon the sensor hardware and ML application, the time-series required to train a model adequately may span more than the FOV of a single sensor. For example, suppose that the deployment in the above diagram has the following characteristics: the sensor samples at 10 samples per second; a person running crosses the FOV of a sensor in roughly 2 seconds; an ML model requires a time-series sample of 30 steps to learn the difference between a running person and a running deer. In this example, the data from a single sensor is inadequate to train the model. [In this example: 30 samples/(10 samples/second *2 seconds)=1.5 sensor FOVs−means 2 sensor FOVs are required to get the needed 30 steps for the time-series data.]

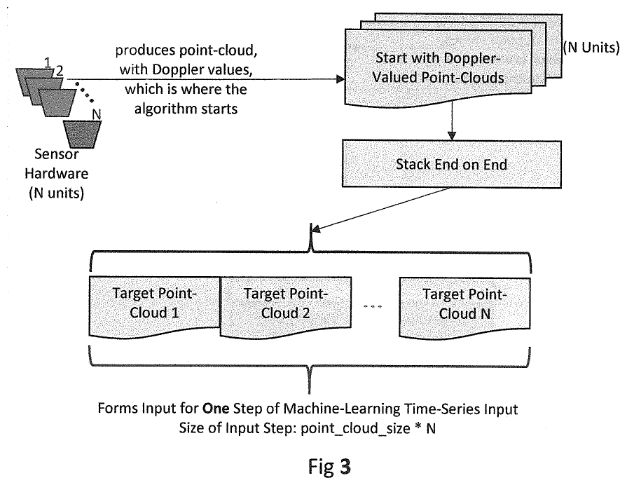

There are a few possible solutions to this problem. One option is to consider the entire sensor deployment as “the input” and append together all the data from all the sensors into a single, unified whole. This is shown in FIG. 3. This solution has the benefit of being simple to understand, but it creates a large input space for the model, which will probably require significantly more input data to train, and a larger, more costly model to deploy and run.

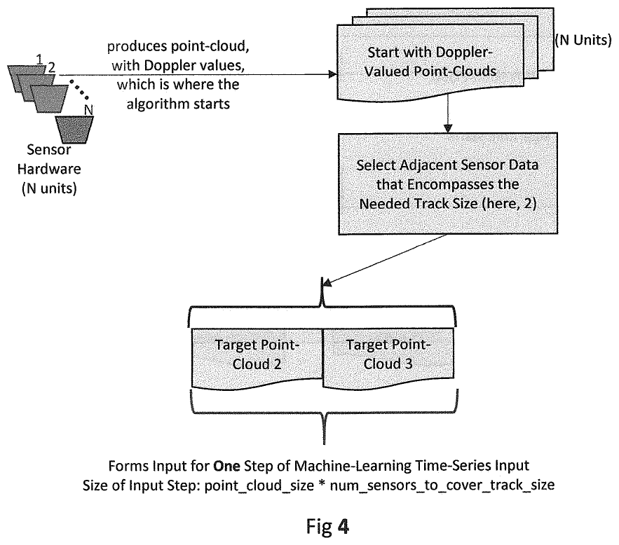

A more sensible variant of this option is to stitch together the sensor fields for only the number of sensors required to encompass the time series (in this case, 2). This is shown in FIG. 4. This is less wasteful, but still creates a large input space for the model, and may require a second instance of the model to be deployed and run, in order to manage the hand-off from one sensor pair to the next.

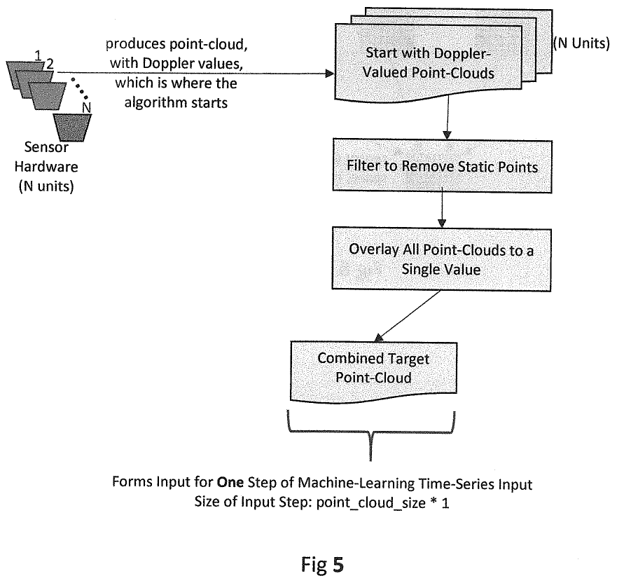

However, if the sensors generating these point-clouds are looking for motion (as previously discussed), then a more elegant solution is possible. Namely, at each time step, the point-clouds from each sensor's FOV are combined by overlaying them into a single point-cloud. This forms the input to the ML model. This is shown in FIG. 5.

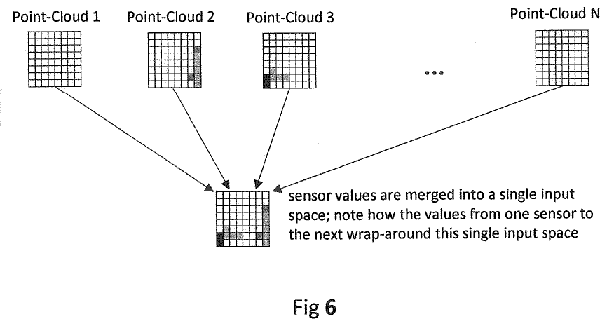

FIG. 6 demonstrates with a 2D example (the technique is applicable to both 2D and 3D sensors), where the darker-colored squares represent a point which has motion. Note that this overlay in effect creates a wrap-around for the overlapping areas of the sensor input. This allows the ML model to learn that overlap and work with longer time series than the original input parameters of the sample data would indicate, while maintaining the same input size for the time-series data.

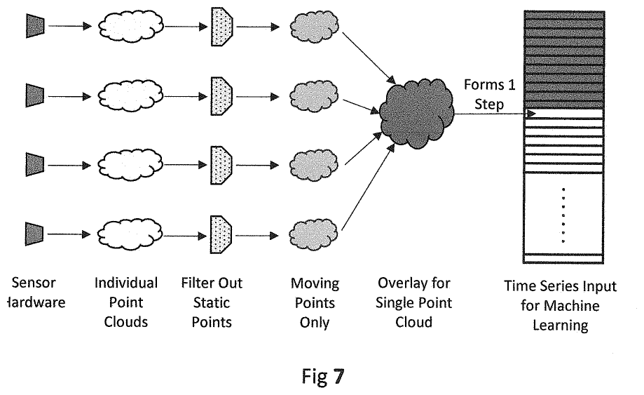

The full technique is shown in FIG. 7. The sensors provide the initial data (point-cloud). The static (unchanging) points are then filtered out, and the resulting moving points are combined into a single, overlayed occupancy grid. This forms the data for a single frame of the time-series input to an ML model.

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the inventive system may look and how the inventive process may be performed. Further, other elements and/or steps may be used for and provide benefits to the present invention. The depictions of the present invention as shown in the exhibits are provided for purposes of illustration.

The embodiments were chosen and described in order to best explain the principles of the invention and its practical application, thereby enabling others of ordinary skill in the art to understand the invention for various embodiments and with various modifications that are suited to the particular use contemplated.

What is claimed is:

1. A system for creating compact expressions of sensor data that can be used as input to machine learning, comprising:
an array of multiple sensors;
a data compressor, electronically connected to the array of multiple sensors, that can format the data in a compact expression; and
a device, electronically connected to the data compressor, that performs machine learning, wherein the device learns the overlay in the compressed data and wherein the data in a compact expression and the learned overlay enables faster and smaller machine learning models.

2. The system of claim 1, further comprising a singular input data space that can collect data individually ported from the array of sensors and make the collected data available to the data compressor.

3. The system of claim 2 further comprising a data storage space, that can electronically receive the data the data compressor and make the compressed data available to the device performing the machine learning.

4. The system of claim 1 wherein the data compressor filters out static points.

5. The system of claim 3 wherein the data in the data storage space accommodates an overlay for a single point.

6. A method of creating compact expressions of sensor data that can be used as input to machine learning, comprising the steps of:
collecting data from an array of multiple sensors;
porting the collected data individually as a singularly input into a data compressor;
compressing the data; and
delivering the compressed data to a device that performs machine learning, wherein the device learns the overlay in the compressed data and wherein the data in a compact expression and the learned overlay enables faster and smaller machine learning models.

7. The method of claim 6 further comprising the step of porting the collected data individually from the array of sensors to a singular input data space and thereafter porting the data as a singularly input into a data compressor.

8. The method of claim 7 further comprising the step of storing the compressed data prior to delivering the compressed data to that device that performs machine learning.

9. The method of claim 6 wherein the data compressor filters out static points.

10. The method of claim 8 wherein the data in the data storage space accommodates an overlay for a single point.
